(19) United States
(12) Patent Application Publication
(10) Pub. No.: US 2026/0184305 A1
(43) Pub. Date: Jul. 2, 2026

(54) Reactive Collision Avoidance

(71) Applicant: NIssan North America, Inc., Franklin, TN (US)

(72) Inventors: Drew Steeves, San Lorenzo, CA (US); Huiching Cheng, San Jose, CA (US); Qizhan Tam, San Jose, CA (US); Christopher Ostafew, Mountain View, CA (US)

(21) Appl. No.: 19/003,188

(22) Filed: Dec. 27, 2024

(51) Int. Cl. B60W 30/095; B60W 50/00; G08G 1/16

(52) U.S. Cl. CPC B60W 30/0956; B60W 50/0098; G08G 1/16; B60W 2520/06; B60W 2520/10; B60W 2554/802

(57) ABSTRACT

A system and method for reactive collision avoidance for autonomous vehicles for avoiding collisions with late-detected deterministic threats while minimizing deviations from planned trajectories and maximizing safety and comfort for vehicle occupants and others in the environment. Some implementations include receiving control commands for a planned path, determining distances to late-detected objects, determining at least one rate of change of a distance that exceeds a threshold, predicting that a collision will occur based on a collision function, and modifying at least one of the control commands to avoid the collision.

### TECHNICAL FIELD

This disclosure relates generally to reactive collision avoidance for autonomous vehicles, and more specifically, to systems and methods that can integrate with existing trajectory planners and/or proactive collision avoidance systems to enable autonomous vehicles to avoid collisions with late-detected deterministic threats while minimizing deviations from planned trajectories and maximizing safety and comfort for vehicle occupants and others in the environment

### BACKGROUND

Autonomous driving systems aim to navigate vehicles from a starting pose to a goal pose while ensuring safety and comfort for passengers and others in the environment. This involves accurately moving the vehicle through intermediate poses in accordance with a speed profile. A pose of a vehicle may comprise, for example, a tuple (x, y, θ) where x a is a longitudinal position, y is a lateral position, and θ is a yaw (the pose may also comprise time derivatives of these variables).

Autonomous driving of an autonomous vehicle may be achieved in part by systems and processes that receive and/or analyzes information based on sensor data, map data, and a world model to determine a trajectory for the vehicle, e.g., a planned path, that can be translated into corresponding control commands, such as steering, braking, and accelerating, to cause the vehicle to follow the planned path. The planned path may be, for example, a series of tuples tuple (x, y, θ, t), where t is a time component. As the vehicle advances along the planned path, e.g., it drives autonomously, the systems and processes may update the planned path and the corresponding control commands based on new collision threats it perceives in the environment.

Collision threats can emerge with varying degrees of urgency. Early-detected deterministic threats, such as a parked car or a dumpster, may allow the autonomous driving system to proactively plan and execute avoidance strategies as part of a planned path, ensuring safety without abrupt maneuvers. Conversely, late-detected deterministic threats, such as a car door opening unexpectedly or a child entering the street, may require reactive control strategies. Although some late-detected threats can be mitigated through proactive risk mitigation (PRM), it becomes computationally impractical or infeasible to ensure comprehensive safety against all potential scenarios at all times.

### SUMMARY

Autonomous driving systems can benefit from a reactive collision avoidance system (RCAS) to address some or all of the challenges described above. This disclosure focuses on systems and methods for RCAS that enable autonomous vehicles to effectively avoid collisions with late-detected deterministic threats. In some implementations, the RCAS integrates with an existing PRM to enable an autonomous vehicle to avoid collisions with late-detected deterministic threats that may be difficult, impractical, or impossible to avoid by the PRM while minimizing deviations from a planned path and maximizing safety and comfort for vehicle occupants and others in the environment.

Specifically, disclosed herein are aspects, features, elements, implementations, and embodiments of a method, a system, and a non-transitory computer-readable medium for reactive collision avoidance for autonomous vehicles.

A first aspect of the disclosed implementations is a method that includes the steps of: obtaining control commands for executing a planned path of a vehicle; obtaining, from a sensor system of the vehicle, sensor data indicating a set of points of the vehicle and a set of points of a set of objects; determining respective distances between the set of points of the vehicle and the set of points of the set of objects; determining a rate of change for each distance; determining that at least one rate of change for a given distance exceeds a predefined threshold; determining a prediction, based on a collision function of the given distance, that the control commands will result in a collision between the vehicle and an object of the set of objects; and in response to the prediction, determining at least one modified control command, based on at least one of the control commands, to avoid the collision.

A second aspect of the disclosed implementations is a system that includes one or more memories and one or more processors configured to execute instructions stored in the one or more memories to implement the steps of the method described above.

A third aspect of the disclosed implementations is a non-transitory computer-readable medium storing instructions operable to cause one or more processors to perform operations according to the steps of the method described above.

As used herein, the term “vehicle” encompasses “autonomous vehicle,” “self-driving vehicle,” and similar terms unless stated otherwise or indicated by context. For simplicity and brevity, the term “late-detected deterministic threat” may be referred to simply as a “late-detected threat” or a “threat” in appropriate contexts. The terms “threat” and “risk” may be used interchangeably herein in appropriate contexts. The terms “trajectory,” “path,” and “route” may be used interchangeably herein in appropriate contexts and may encompass “planned trajectory,” “planned path,” and “planned route” unless stated otherwise or indicated by context.

### BRIEF DESCRIPTION OF THE DRAWINGS

The various aspects of the methods and systems disclosed herein will become more apparent by referring to the examples provided in the following description and drawings in which like reference numbers refer to like elements unless otherwise noted.

FIG. 1 is a diagram of an example of a portion of a vehicle in which the aspects, features, and elements disclosed herein may be implemented.

FIG. 2 is a diagram of an example of a portion of a vehicle transportation and communication system in which the aspects, features, and elements disclosed herein may be implemented.

FIG. 3 is a block diagram of an example internal configuration of a computing device of an electronic computing and communications system in which the aspects, features, and elements disclosed herein may be implemented.

FIG. 4 is a diagram of an example of a system for determining a planned path for a vehicle and for following the planned path.

FIG. 5 is a diagram of an example of a system for reactive collision avoidance.

FIGS. 6A, 6B, and 6C are respective examples directed to critical point abstraction.

FIG. 7 is a diagram of an example of a framework for using control barrier functions.

FIG. 8 is a flowchart of an example of a process for reactive collision avoidance.

### DETAILED DESCRIPTION

To describe some implementations in greater detail, reference is made to the following figures.

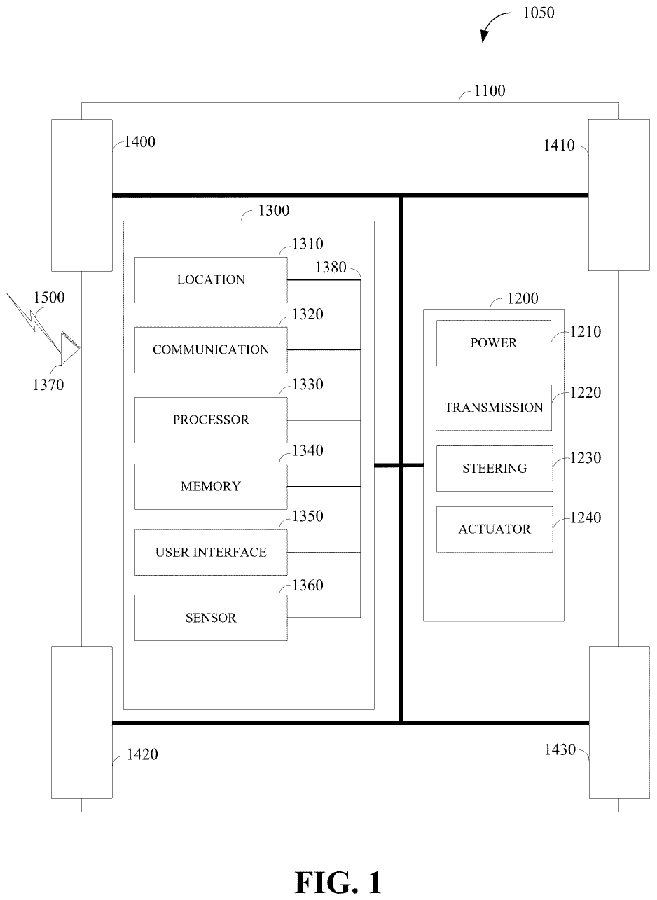

FIG. 1 is a diagram of an example of a vehicle 1050 in which the aspects, features, and elements disclosed herein may be implemented. The vehicle 1050 may include a chassis 1100, a powertrain 1200, a controller 1300, wheels 1400/1410/1420/1430, or any other element or combination of elements of a vehicle. Although the vehicle 1050 is shown as including four wheels 1400/1410/1420/1430 for simplicity, any other propulsion device or devices, such as a propeller or tread, may be used. In FIG. 1, the lines interconnecting elements, such as the powertrain 1200, the controller 1300, and the wheels 1400/1410/1420/1430, indicate that information, such as data or control signals, power, such as electrical power or torque, or both information and power, may be communicated between the respective elements. For example, the controller 1300 may receive power from the powertrain 1200 and communicate with the powertrain 1200, the wheels 1400/1410/1420/1430, or both, to control the vehicle 1050, which can include accelerating, decelerating, steering, or otherwise controlling the vehicle 1050.

The powertrain 1200 includes a power source 1210, a transmission 1220, a steering unit 1230, a vehicle actuator 1240, or any other element or combination of elements of a powertrain, such as a suspension, a drive shaft, axles, or an exhaust system. Although shown separately, the wheels 1400/1410/1420/1430 may be included in the powertrain 1200. A braking system may be included in the vehicle actuator 1240.

The power source 1210 may be any device or combination of devices operative to provide energy, such as electrical energy, chemical energy, or thermal energy. For example, the power source 1210 includes an engine, such as an internal combustion engine, an electric motor, or a combination of an internal combustion engine and an electric motor, and is operative to provide energy as a motive force to one or more of the wheels 1400/1410/1420/1430. In some embodiments, the power source 1210 includes a potential energy unit, such as one or more dry cell batteries, such as nickel-cadmium (NiCd), nickel-zinc (NiZn), nickel metal hydride (NiMH), lithium-ion (Li-ion); solar cells; fuel cells; or any other device capable of providing energy.

The transmission 1220 receives energy from the power source 1210 and transmits the energy to the wheels 1400/1410/1420/1430 to provide a motive force. The transmission 1220 may be controlled by the controller 1300, the vehicle actuator 1240 or both. The steering unit 1230 may be controlled by the controller 1300, the vehicle actuator 1240, or both and controls the wheels 1400/1410/1420/1430 to steer the vehicle. The vehicle actuator 1240 may receive signals from the controller 1300 and may actuate or control the power source 1210, the transmission 1220, the steering unit 1230, or any combination thereof to operate the vehicle 1050.

In some embodiments, the controller 1300 includes a location unit 1310, an electronic communication unit 1320, a processor 1330, a memory 1340, a user interface 1350, a sensor 1360, an electronic communication interface 1370, or any combination thereof. Although shown as a single unit, any one or more elements of the controller 1300 may be integrated into any number of separate physical units. For example, the user interface 1350 and processor 1330 may be integrated in a first physical unit and the memory 1340 may be integrated in a second physical unit. Although not shown in FIG. 1, the controller 1300 may include a power source, such as a battery. Although shown as separate elements, the location unit 1310, the electronic communication unit 1320, the processor 1330, the memory 1340, the user interface 1350, the sensor 1360, the electronic communication interface 1370, or any combination thereof can be integrated in one or more electronic units, circuits, or chips.

In some embodiments, the processor 1330 includes any device or combination of devices capable of manipulating or processing a signal or other information now existing or hereafter developed, including optical processors, quantum processors, molecular processors, or a combination thereof. For example, the processor 1330 may include one or more special purpose processors, one or more digital signal processors, one or more microprocessors, one or more controllers, one or more microcontrollers, one or more integrated circuits, one or more an application-specific integrated circuits (ASICs), one or more field-programmable gate arrays (FPGAs), one or more programmable logic arrays (PLAs), one or more programmable logic controllers (PLCs), one or more state machines, or any combination thereof. The processor 1330 may be operatively coupled with the location unit 1310, the memory 1340, the electronic communication interface 1370, the electronic communication unit 1320, the user interface 1350, the sensor 1360, the powertrain 1200, or any combination thereof. For example, the processor may be operatively coupled with the memory 1340 via a communication bus 1380.

In some embodiments, the processor 1330 may be configured to execute instructions including instructions for remote operation which may be used to operate the vehicle 1050 from a remote location including a data-processing center. The instructions for remote operation may be stored in the vehicle 1050 or received from an external source such as a traffic management center, or server computing devices, which may include cloud-based server computing devices. The processor 1330 may be configured to execute instructions for following a projected path as described herein.

The memory 1340 may include any tangible non-transitory computer-usable or computer-readable medium, capable of, for example, containing, storing, communicating, or transporting machine readable instructions or any information associated therewith, for use by or in connection with the processor 1330. The memory 1340 is, for example, one or more solid state drives, one or more memory cards, one or more removable media, one or more read only memories, one or more random access memories, one or more solid-state drives, one or more disks, including a hard disk, a floppy disk, an optical disk, a magnetic or optical card, or any type of non-transitory media suitable for storing electronic information, or any combination thereof.

The electronic communication interface 1370 may be a wireless antenna, as shown, a wired communication port, an optical communication port, or any other wired or wireless unit capable of interfacing with a wired or wireless electronic communication medium 1500.

The electronic communication unit 1320 may be configured to transmit or receive signals via the wired or wireless electronic communication medium 1500, such as via the electronic communication interface 1370. Although not explicitly shown in FIG. 1, the electronic communication unit 1320 is configured to transmit, receive, or both via any wired or wireless communication medium, such as radio frequency (RF), ultraviolet (UV), visible light, fiber optic, wire line, or a combination thereof. Although FIG. 1 shows a single one of the electronic communication unit 1320 and a single one of the electronic communication interface 1370, any number of communication units and any number of communication interfaces may be used. In some embodiments, the electronic communication unit 1320 can include a dedicated short-range communications (DSRC) unit, a wireless safety unit (WSU), IEEE 802.11p (WiFi-P), a cellular communication unit such as a long-term evolution (LTE) or 5G transceiver, or a combination thereof.

The location unit 1310 may determine geolocation information, including but not limited to longitude, latitude, elevation, direction of travel, or speed, of the vehicle 1050. For example, the location unit includes a global navigation satellite system (GNSS) unit (e.g., a global positioning system (GPS) unit), a wide area augmentation system (WAAS) enabled National Marine-Electronics Association (NMEA) unit, a radio triangulation unit, or a combination thereof. The location unit 1310 can be used to obtain information that represents, for example, a current heading of the vehicle 1050, a current position of the vehicle 1050 in two or three dimensions, a current angular orientation of the vehicle 1050, or a combination thereof.

The user interface 1350 may include any unit capable of being used as an interface by a person, including any of a virtual keypad, a physical keypad, a touchpad, a display, a touchscreen, a speaker, a microphone, a video camera, a sensor, and a printer. The user interface 1350 may be operatively coupled with the processor 1330, as shown, or with any other element of the controller 1300. Although shown as a single unit, the user interface 1350 can include one or more physical units. For example, the user interface 1350 includes an audio interface for performing audio communication with a person, and a touch display for performing visual and touch based communication with the person.

The sensor 1360 may include one or more sensors, such as an array of sensors, which may be operable to provide information that may be used to control the vehicle. The sensor 1360 can provide information regarding current operating characteristics of the vehicle or its surrounding. The sensors 1360 include, for example, a speed sensor, acceleration sensors, a steering angle sensor, traction-related sensors, braking-related sensors, or any sensor, or combination of sensors, that is operable to report information regarding some aspect of the current dynamic situation of the vehicle 1050.

In some embodiments, the sensor 1360 may include sensors that are operable to obtain information regarding the physical environment within or surrounding the vehicle 1050. With regard to within the vehicle 1050, e.g., the in-cabin environment, one or more sensors may detect objects within the vehicle, such as groceries, electronic devices, pets, people, in-vehicle controls, and so on. With respect to surrounding the vehicle, e.g., the external, exterior, or outside environment, one or more sensors may detect road geometry and obstacles, such as fixed obstacles, vehicles, cyclists, and pedestrians. In some embodiments, the sensor 1360 can be or include one or more still or video cameras, laser-sensing systems, infrared-sensing systems, acoustic-sensing systems, or any other suitable type of on-vehicle environmental sensing device, or combination of devices, now known or later developed. In some embodiments, the sensor 1360 and the location unit 1310 are combined.

Although not shown separately, the vehicle 1050 may include a trajectory controller. For example, the controller 1300 may include a trajectory controller. The trajectory controller may be operable to obtain information describing a current state of the vehicle 1050 and a route planned for the vehicle 1050, and, based on this information, to determine and optimize a trajectory for the vehicle 1050. In some embodiments, the trajectory controller outputs signals operable to control the vehicle 1050 such that the vehicle 1050 follows the trajectory that is determined by the trajectory controller. For example, the output of the trajectory controller can be an optimized trajectory that may be supplied to the powertrain 1200, the wheels 1400/1410/1420/1430, or both. In some embodiments, the optimized trajectory can control inputs such as a set of steering angles, with each steering angle corresponding to a point in time or a position. In some embodiments, the optimized trajectory can be one or more paths, lines, curves, or a combination thereof.

One or more of the wheels 1400/1410/1420/1430 may be a steered wheel, which is pivoted to a steering angle under control of the steering unit 1230, a propelled wheel, which is torqued to propel the vehicle 1050 under control of the transmission 1220, or a steered and propelled wheel that steers and propels the vehicle 1050.

A vehicle may include units, or elements not shown in FIG. 1, such as an enclosure, a Bluetooth® module, a frequency modulated (FM) radio unit, a Near Field Communication (NFC) module, a liquid crystal display (LCD) display unit, an organic light-emitting diode (OLED) display unit, a speaker, or any combination thereof.

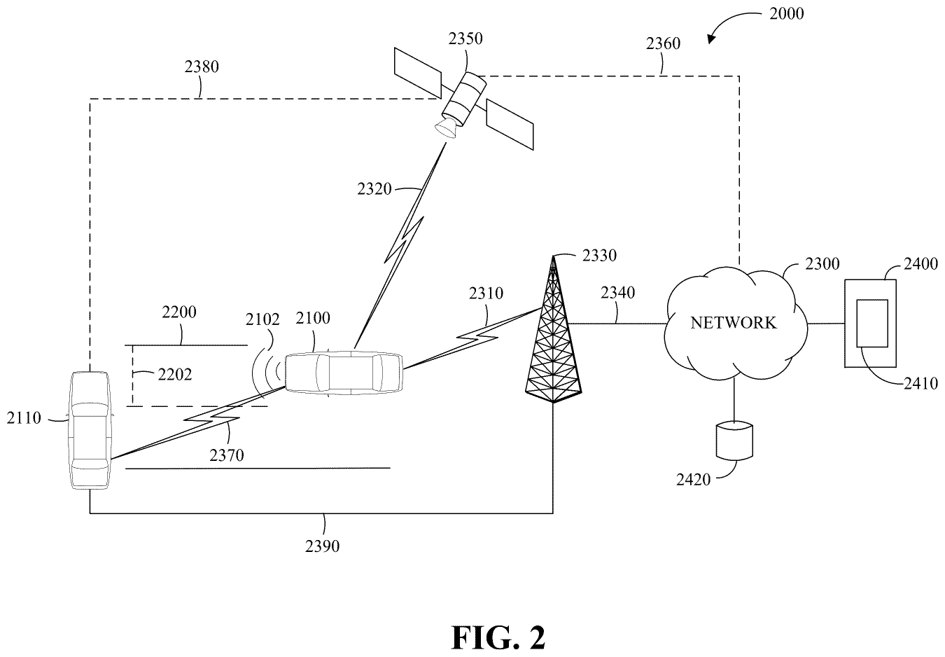

FIG. 2 is a diagram of an example of a portion of a vehicle transportation and communication system 2000 in which the aspects, features, and elements disclosed herein may be implemented. The vehicle transportation and communication system 2000 includes a vehicle 2100, such as the vehicle 1050 shown in FIG. 1, and one or more external objects, such as an external object 2110, which can include any form of transportation, such as the vehicle 1050 shown in FIG. 1, a pedestrian, cyclist, as well as any form of a structure, such as a building. The vehicle 2100 may travel via one or more portions of a transportation network 2200, and may communicate with the external object 2110 via one or more of an electronic communication network 2300. Although not explicitly shown in FIG. 2, a vehicle may traverse an area that is not expressly or completely included in a transportation network, such as an off-road area. In some embodiments the transportation network 2200 may include one or more of a vehicle detection sensor 2202, such as an inductive loop sensor, which may be used to detect the movement of vehicles on the transportation network 2200.

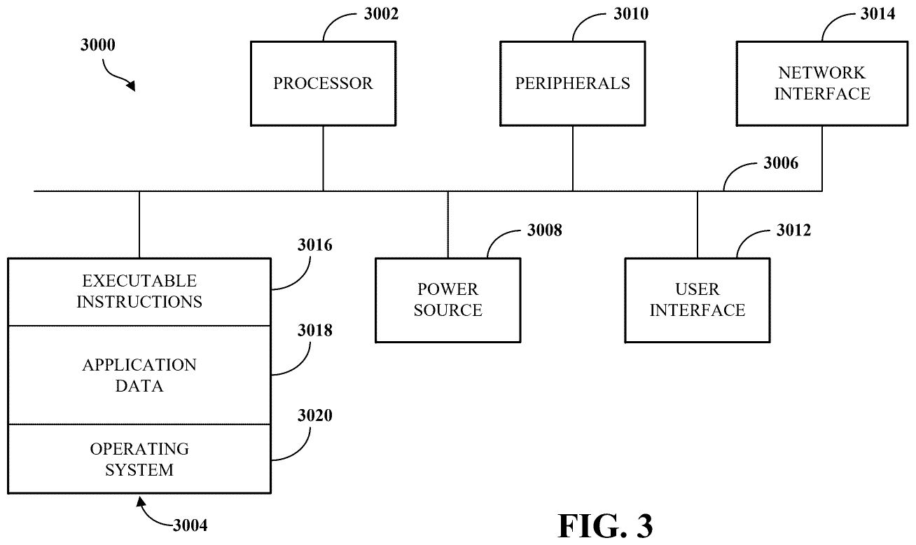

The electronic communication network 2300 may be a multiple-access system that provides for communication, such as voice communication, data communication, video communication, messaging communication, or a combination thereof, between the vehicle 2100, the external object 2110, and a data-processing center 2400. For example, the vehicle 2100 or the external object 2110 may send information to, or receive information from, the data-processing center 2400 or a database server 2420, via the electronic communication network 2300, such as information representing the transportation network 2200. The data-processing center 2400 includes a computing apparatus 2410, that includes some or all of the features of the computing device 3000 shown in FIG. 3, which is described later herein. In some implementations, the data-processing center 2400 includes the database server 2420. The database server 2420 is configured for storing data, and it may be implemented by a suitable computer storage medium.

The data-processing center 2400 can monitor and coordinate the movement of vehicles, including autonomous vehicles. The data-processing center 2400 may monitor the state or condition of vehicles, such as the vehicle 2100, and external objects, such as the external object 2110. The data-processing center 2400 can receive vehicle data and infrastructure data including any of: vehicle velocity; vehicle location; vehicle operational state; vehicle destination; vehicle route; vehicle sensor data; external object velocity; external object location; external object operational state; external object destination; external object route; and external object sensor data.

Further, the data-processing center 2400 can establish remote control over one or more vehicles, such as the vehicle 2100, or external objects, such as the external object 2110. In this way, the data-processing center 2400 may tele-operate the vehicles or external objects from a remote location. The computing apparatus 2410 may exchange (send or receive) state data with vehicles, external objects, or computing devices such as the vehicle 2100, the external object 2110, or the database server 2420, via a wireless communication link such as the wireless communication link 2380 or a wired communication link such as the wired communication link 2390.

In some embodiments, the vehicle 2100 or the external object 2110 communicates via the wired communication link 2390, a wireless communication link 2310/2320/2370, or a combination of any number or types of wired or wireless communication links. For example, as shown, the vehicle 2100 or the external object 2110 communicates via a terrestrial wireless communication link 2310, via a non-terrestrial wireless communication link 2320, or via a combination thereof. In some implementations, a terrestrial wireless communication link 2310 includes an Ethernet link, a serial link, a Bluetooth link, an infrared (IR) link, an ultraviolet (UV) link, or any link capable of providing for electronic communication.

A vehicle, such as the vehicle 2100, or an external object, such as the external object 2110, may communicate with another vehicle, external object, or the data-processing center 2400. For example, a host, or subject, vehicle 2100 may receive one or more automated inter-vehicle messages, such as a basic safety message (BSM), from the data-processing center 2400, via a direct communication link 2370, or via an electronic communication network 2300. For example, data-processing center 2400 may broadcast the message to host vehicles within a defined broadcast range, such as three hundred meters, or to a defined geographical area. In some embodiments, the vehicle 2100 receives a message via a third party, such as a signal repeater (not shown) or another remote vehicle (not shown). In some embodiments, the vehicle 2100 or the external object 2110 transmits one or more automated inter-vehicle messages periodically based on a defined interval, such as one hundred milliseconds.

Automated inter-vehicle messages may include vehicle identification information, geospatial state information, such as longitude, latitude, or elevation information, geospatial location accuracy information, kinematic state information, such as vehicle acceleration information, yaw rate information, speed information, vehicle heading information, braking system state data, throttle information, steering wheel angle information, or vehicle routing information, or vehicle operating state information, such as vehicle size information, headlight state information, turn signal information, wiper state data, transmission information, or any other information, or combination of information, relevant to the transmitting vehicle state. For example, transmission state information indicates whether the transmission of the transmitting vehicle is in a neutral state, a parked state, a forward state, or a reverse state.

In some embodiments, the vehicle 2100 communicates with the electronic communication network 2300 via an access point 2330. The access point 2330, which may include a computing device, may be configured to communicate with the vehicle 2100, with the electronic communication network 2300, with the data-processing center 2400, or with a combination thereof via wired or wireless communication links 2310/2340. For example, an access point 2330 is a base station, a base transceiver station (BTS), a Node-B, an enhanced Node-B (eNode-B), a Home Node-B (HNode-B), a wireless router, a wired router, a hub, a relay, a switch, or any similar wired or wireless device. Although shown as a single unit, an access point can include any number of interconnected elements.

The vehicle 2100 may communicate with the electronic communication network 2300 via a satellite 2350, or other non-terrestrial communication device. The satellite 2350, which may include a computing device, may be configured to communicate with the vehicle 2100, with the electronic communication network 2300, with the data-processing center 2400, or with a combination thereof via one or more communication links 2320/2360. Although shown as a single unit, a satellite can include any number of interconnected elements.

The electronic communication network 2300 may be any type of network configured to provide for voice, data, or any other type of electronic communication. For example, the electronic communication network 2300 includes a local area network (LAN), a wide area network (WAN), a virtual private network (VPN), a mobile or cellular telephone network, the Internet, or any other electronic communication system. The electronic communication network 2300 may use a communication protocol, such as the transmission control protocol (TCP), the user datagram protocol (UDP), the internet protocol (IP), the real-time transport protocol (RTP) the Hyper Text Transport Protocol (HTTP), or a combination thereof. Although shown as a single unit, an electronic communication network can include any number of interconnected elements.

In some embodiments, the vehicle 2100 communicates with the data-processing center 2400 via the electronic communication network 2300, access point 2330, or satellite 2350. The data-processing center 2400 may include one or more computing devices, which are able to exchange (send or receive) data from: vehicles such as the vehicle 2100; external objects including the external object 2110; or storage devices such as the database server 2420.

In some embodiments, the vehicle 2100 identifies a portion or condition of the transportation network 2200. For example, the vehicle 2100 may include one or more on-vehicle sensors 2102, such as the sensor 1360 shown in FIG. 1, which includes a speed sensor, a wheel speed sensor, a camera, a gyroscope, an optical sensor, a laser sensor, a radar sensor, a sonic sensor (e.g., a microphone or acoustic sensor), a compass, or any other sensor or device or combination thereof capable of determining or identifying a portion or condition of the transportation network 2200.

The vehicle 2100 may traverse one or more portions of the transportation network 2200 using information communicated via the electronic communication network 2300, such as information representing the transportation network 2200, information identified by one or more on-vehicle sensors 2102, or a combination thereof. The external object 2110 may be capable of all or some of the communications and actions described above with respect to the vehicle 2100.

For simplicity, FIG. 2 shows the vehicle 2100 as the host vehicle, the external object 2110, the transportation network 2200, the electronic communication network 2300, and the data-processing center 2400. However, any number of vehicles, networks, or computing devices may be used. In some embodiments, the vehicle transportation and communication system 2000 includes devices, units, or elements not shown in FIG. 2. Although the vehicle 2100 or external object 2110 is shown as a single unit, a vehicle can include any number of interconnected elements.

Although the vehicle 2100 is shown communicating with the data-processing center 2400 via the electronic communication network 2300, the vehicle 2100 (and external object 2110) may communicate with the data-processing center 2400 via any number of direct or indirect communication links. For example, the vehicle 2100 or external object 2110 may communicate with the data-processing center 2400 via a direct communication link, such as a Bluetooth communication link. Although, for simplicity, FIG. 2 shows one of the transportation network 2200, and one of the electronic communication network 2300, any number of networks or communication devices may be used. The vehicle 2100 (and external object 2110) can be monitored or coordinated by the data-processing center 2400, can be operated autonomously or by a human driver, and can exchange (send and receive) vehicle data relating to the state or condition of the vehicle and its surroundings including any of vehicle velocity (e.g., vehicle speed and vehicle trajectory, or heading); vehicle location; vehicle operational state; vehicle destination; vehicle route; vehicle sensor data; external object velocity; external object location, and so on.

FIG. 3 shows a block diagram of an example of a computing device 3000 in which certain aspects, features, and elements disclosed herein may be implemented. The computing device 3000 may be, for example, the controller 1300 shown in FIG. 1 or the computing apparatus 2410 shown in FIG. 2. The computing device 3000 includes components or units, such as a processor 3002, a memory 3004, a bus 3006, a power source 3008, peripherals 3010, a user interface 3012, a network interface 3014, other suitable components, or a combination thereof. One or more of the memory 3004, the power source 3008, the peripherals 3010, the user interface 3012, or the network interface 3014 can communicate with the processor 3002 via the bus 3006.

The processor 3002 is a central processing unit, such as a microprocessor, and can include single or multiple processors having single or multiple processing cores. Alternatively, the processor 3002 can include another type of device, or multiple devices, configured for manipulating or processing information. For example, the processor 3002 can include multiple processors interconnected in one or more manners, including hardwired or networked. The operations of the processor 3002 can be distributed across multiple devices or units that can be coupled directly or across a local area or other suitable type of network. The processor 3002 can include a cache, or cache memory, for local storage of operating data or instructions.

The memory 3004 includes one or more memory components, which may each be volatile memory or non-volatile memory. For example, the volatile memory can be random access memory (RAM) (e.g., a DRAM module, such as DDR SDRAM). In another example, the non-volatile memory of the memory 3004 can be a disk drive, a solid state drive, flash memory, or phase-change memory. In some implementations, the memory 3004 can be distributed across multiple devices. For example, the memory 3004 can include network-based memory or memory in multiple clients or servers performing the operations of those multiple devices.

The memory 3004 can include data for immediate access by the processor 3002. For example, the memory 3004 can include executable instructions 3016, application data 3018, and an operating system 3020. The executable instructions 3016 can include one or more application programs, which can be loaded or copied, in whole or in part, from non-volatile memory to volatile memory to be executed by the processor 3002. For example, the executable instructions 3016 can include instructions for performing techniques of this disclosure. In some implementations, the application data 3018 can include functional programs, such as a computational programs, analytical programs, database programs, and so on. The operating system 3020 can be, for example, Microsoft Windows®, Mac OS X®, or Linux®; an operating system for a mobile device, such as a smartphone or tablet device; or an operating system for a non-mobile device, such as a mainframe computer.

The power source 3008 provides power to the computing device 3000. For example, the power source 3008 can be an interface to an external power distribution system. In another example, the power source 3008 can be a battery, such as where the computing device 3000 is a mobile device or is otherwise configured to operate independently of an external power distribution system. In some implementations, the computing device 3000 may include or otherwise use multiple power sources. In some such implementations, the power source 3008 can be a backup battery.

The peripherals 3010 may include one or more sensors, detectors, or other devices configured for monitoring the computing device 3000 or the environment around the computing device 3000. For example, the peripherals 3010 can include a geolocation component, such as a GNSS location unit (e.g., GPS). In another example, the peripherals can include a temperature sensor for measuring temperatures of components of the computing device 3000, such as the processor 3002. In some implementations, the computing device 3000 can omit the peripherals 3010.

The user interface 3012 includes one or more input interfaces and/or output interfaces. An input interface may, for example, be a positional input device, such as a mouse, touchpad, touchscreen, or the like; a keyboard; or another suitable human or machine interface device. An output interface may, for example, be a display, such as a liquid crystal display, a cathode-ray tube, a light emitting diode display, or other suitable display.

The network interface 3014 provides a connection or link to a network (e.g., the electronic communication network 2300 shown in FIG. 2). The network interface 3014 can be a wired network interface or a wireless network interface. The computing device 3000 can communicate with other devices via the network interface 3014 using one or more network protocols, such as using Ethernet, transmission control protocol (TCP), internet protocol (IP), power line communication, an IEEE 802.X protocol (e.g., Wi-Fi, Bluetooth, or ZigBee), infrared, visible light, general packet radio service (GPRS), global system for mobile communications (GSM), code-division multiple access (CDMA), Z-Wave, another protocol, or a combination thereof. For example, the computing device 3000 can communicate with a database server, such as the database server 2420 of FIG. 2.

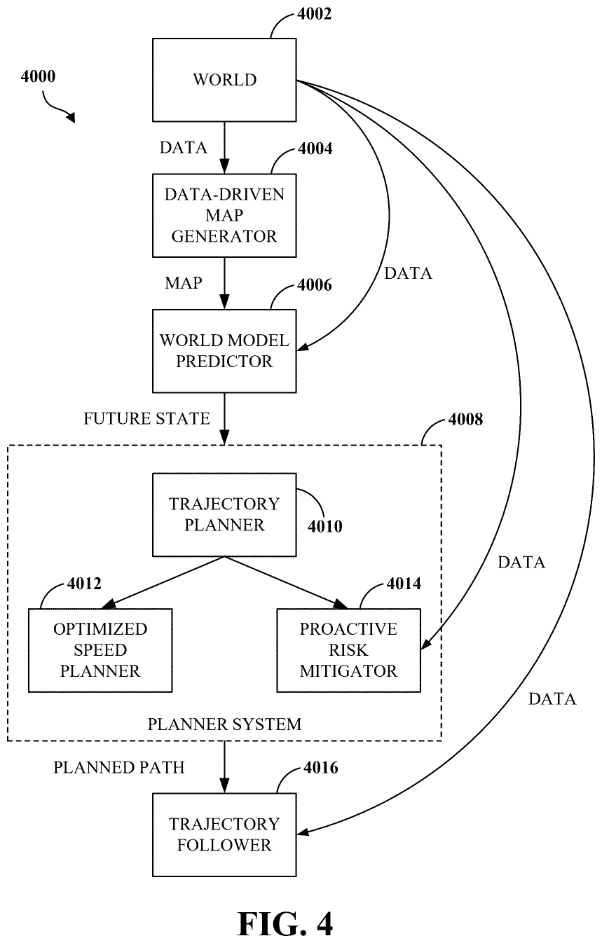

FIG. 4 is a diagram of an example of a system 4000 for determining a planned path for a vehicle and for following the planned path. The vehicle may be, for example, the vehicle 1050 as shown in FIG. 1. The world 4002 represents the world, or more specifically, an environment in a vicinity of the vehicle, including the vehicle itself, for example, an area having a radius of 100 feet around the vehicle and an accompanying vertical dimension, such as 15 feet. The world may be determined based on data collected by one or more sensors of the vehicle, such as the sensor 1360 shown in FIG. 1. The data from these sensors may indicate, or be used to determine, a pose of the vehicle. In some implementations, the pose may comprise a tuple (x, y, θ), and in other implementations the pose may comprise a tuple (x, y, θ, \dot{x}, \dot{y}, \dot{θ}), where x and y are location coordinates, θ is a yaw of the vehicle, and the dotted elements are first derivatives with respect to time, e.g., rates of change, of the respective un-dotted elements.

Data, which may comprise unprocessed, preprocessed, or processed data, is provided by the world 4002 to the data-driven map generator 4004, which generates a map useful for determining a trajectory of the vehicle. The map may represent relatively static or semi-static elements, such as a network of roads and streets, buildings, construction zones, and so on, and the map may also represent relatively dynamic elements, such as moving or moveable objects or obstacles detected by sensors of the vehicle. Such dynamic elements may comprise early-detected deterministic threats. The map may be considered a current state of the world.

The map is provided by the data-driven map generator 4004 to the world model predictor 4006, which forecasts, or predicts, a future state of the environment based on the map, e.g., based on the current state of the world. The world model predictor 4006 predicts how dynamic elements, which may include other vehicles, pedestrians, or cyclists, are likely to move over time, as well as potential changes in static or semi-static elements, such as traffic signals or construction zones. Accordingly, the world model predictor 4006 enables proactive and safe trajectory planning for the vehicle, allowing the system 4000 to adjust speed, change lanes, or take other actions to avoid collisions.

The future state of the environment is provided by the world model predictor 4006 to the planner system 4008, which includes a trajectory planner 4010, an optimized speed planner 4012, and a proactive risk mitigator 4014.

The trajectory planner 4010 determines a trajectory, or planned path, for the vehicle based on at least the future state of the environment (it may also, for example, utilize the current state of the environment). The planned path is a path that the vehicle can follow to advance toward an eventual destination and to avoid collisions with threats that are modeled by the data-driven map generator 4004 and advanced in time by the world model predictor 4006. As indicated earlier, a planned path may comprise a time series of tuples (x, y, θ, t).

The optimized speed planner 4012 determines an optimal speed for the vehicle according to the planned path. In some implementations the optimized speed planner 4012 determines a set or series of optimal speeds at various waypoints along the planned path, e.g., an optimized speed profile. In determining an optimal speed, the optimized speed planner 4012 may consider, for example, actuator limits of actuators of the vehicle, such as maximum acceleration, maximum deceleration, steering slew rate, and so on. Actuators of the vehicle may be, for example, the actuator 1240 shown in FIG. 1. The optimized speed planner 4012 further consider comfort constraints for occupants of the vehicle, such as empirically determined limits on acceleration and deceleration, jerk, lateral forces, vibrations, road feedback, and so on. For simplicity herein, the speed profile may be considered as a component of the planned path, such that mentioning the planned path may imply the included speed profile.

The proactive risk mitigator 4014 anticipates potential risks based on foreseeable risks predicted by the world model predictor 4006, such as some late-detected deterministic threats, e.g., a door of a nearby parked car opening, and adjusts the planned path to avoid or minimize them. Accordingly, the proactive risk mitigator 4014 enables the system 4000 take preemptive actions, like reducing speed, changing lanes, or maintaining greater following distances behind other vehicles. It ensures smoother transitions to maintain passenger comfort while minimizing potential dangers.

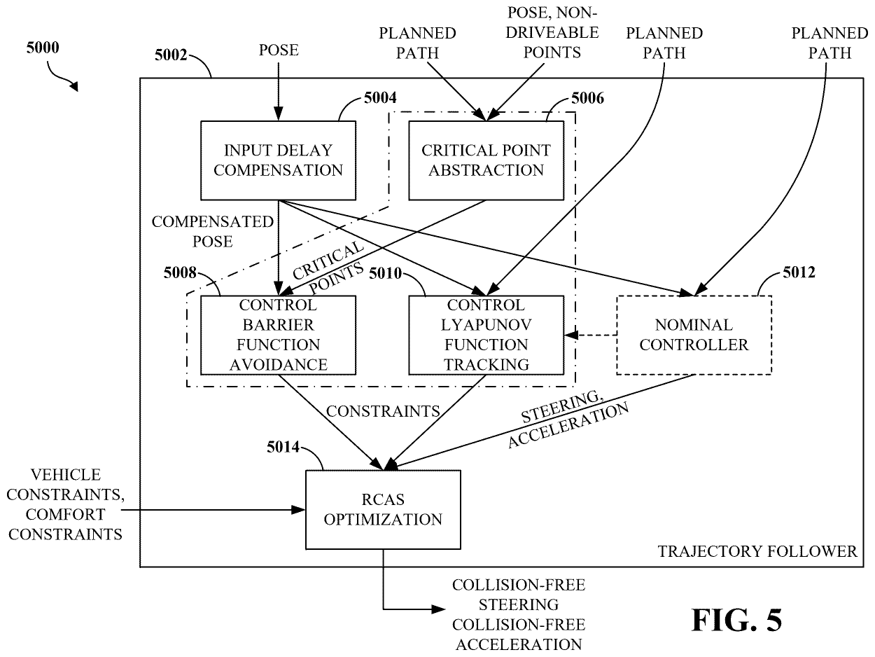

A trajectory follower 4016 receives: (1) the planned path from the planner system 4008, which includes any adjustments made by the proactive risk mitigator 4014 and the accompanying speed profile from the optimized speed planner; and (2) data related to potential additional threats from the world 4002. One aspect of the trajectory follower 4016 is to cause the vehicle to follow the planned path precisely based on control commands derived from the planned path. Another aspect of the trajectory follower 4016 is to modify the control commands to enable the vehicle to avoid collisions with certain late-deterministic threats, as described below with respect to FIGS. 5-7. The control commands and/or modified control commands comprise instructions and/or signals that may be carried out by actuators of the vehicle, such as steering actuators or braking actuators. The control commands and/or modified control commands comprise at least one of a lateral control command, which may be referred to herein as a steering command, or a longitudinal control command, which may be referred to herein as a braking command or an acceleration command. In many implementations, the control commands and/or modified control commands comprise both lateral control commands and longitudinal control commands.

FIG. 5 is a diagram of an example of a system 5000 for reactive collision avoidance. The trajectory follower 5002 may be, for example, the trajectory follower 4016 shown in FIG. 4. The trajectory follower 5002 comprises an input delay compensation 5004, a critical point abstraction 5006, a control barrier function avoidance 5008, a control Lyapunov function tracking 5010, a nominal controller 5012, and an RCAS optimization 5014. Some implementations of the trajectory follower 5002 may include more or fewer components than those illustrated in FIG. 5.

The input delay compensation 5004 receives a pose of the vehicle, for example, a current pose of the vehicle comprised in data received from the world 4002 shown in FIG. 4, and operates to compensate for computational delays incurred by several downstream components. In particular, one aspect of the nominal controller 5012 is to determine the control commands based on the planned path. The nominal controller 5012 operates in parallel with the critical point abstraction 5006, the control barrier function avoidance 5008, and the control Lyapunov function tracking 5010 (outlined by a dashed-dot shape in FIG. 5). Consequently, the control commands may become misaligned in time with the pose received by the trajectory follower 5002. This misalignment can result in oscillations in the vehicle's tracking behavior even when no collision threats are present. Accordingly, the input delay compensation 5004 determines a delay-compensated pose, or simply a compensated pose, so that the RCAS optimization 5014 can operate on time-aligned input values. The input delay compensation 5004 determines the compensated pose based on a kinematic model, for example, the discretized kinematic bicycle model shown below, where L_{f} and Lᵣ denote lengths of the vehicle from center to front and center to rear, respectively, δ denotes a steering angle, a denotes a linear acceleration, vₓ denotes a linear velocity, and the other variables and dotted forms thereof are as described earlier.

$$\dot{x} = {v}_{x} cos ( θ )$$

$$\dot{y} = {v}_{x} sin ( θ )$$

$$\dot{θ} = {v}_{x} \frac{tan ( δ )}{{L}_{f} + {L}_{r}}$$

$${\dot{v}}_{x} = a$$

In some implementations, the delay amount is estimated based on previously measured computation times of the RCAS optimization 5014.

The critical point abstraction 5006 receives the planned path, for example, from the planner system 4008 shown in FIG. 4, and it receives the pose and non-driveable points which may be comprised in data received from the world 4002 shown in FIG. 4. Non-drivable points are location points through which the vehicle should not attempt to drive, such as points on another vehicle, points on a building, and so on. In some implementations, non-driveable points are points at or near a perimeter of an object, such as a side of another vehicle or a side of a building.

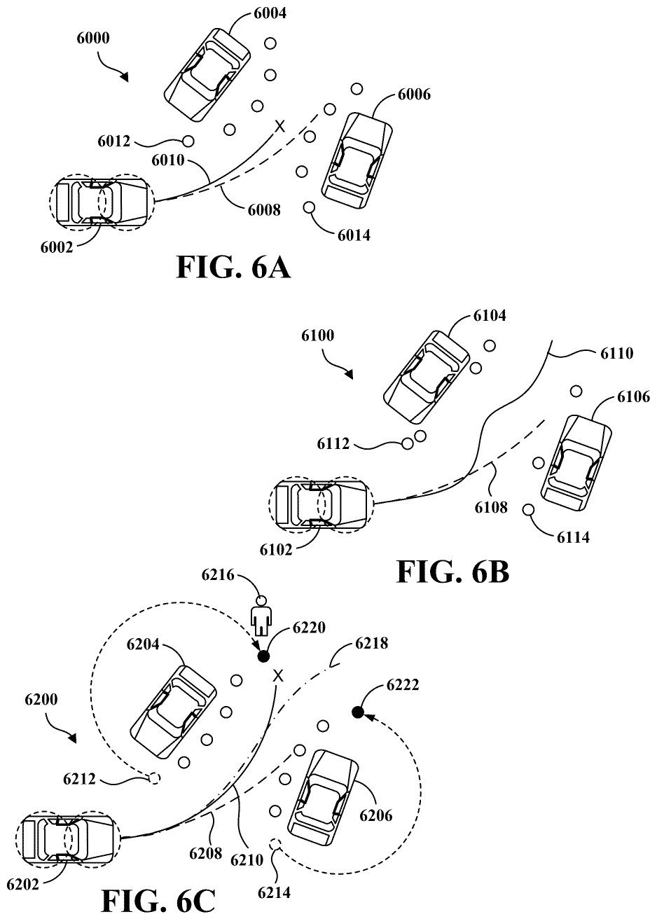

The critical point abstraction 5006 may receive numerous non-driveable points, for example, a comprehensive list of all non-driveable points detected by the world 4002. However, for effective reactive collision avoidance, it may be impractical or infeasible for the trajectory follower 5002 to analyze and consider voluminous non-driveable points. Thus, the critical point abstraction 5006 prunes, filters, or otherwise reduces the set of received non-driveable points it receives to a computationally manageable reduced set, which may be referred to herein as critical points, where the quantity of critical points may vary based on available computational and/or memory resources. In some implementations, the quantity of critical points is based on a required or desired computational speed. For example, in some implementations, the planner system 4008 determines and/or updates the planned path at a frequency of 10 Hz, whereas the reactive collision avoidance system, which comprises the trajectory follower 5002, determines and/or updates the control commands corresponding to a given planned path at a frequency of 100 Hz. In other words, the trajectory follower 5002 may operate at a rate that is an order of magnitude faster than the planner system 4008. In some implementations, the critical point abstraction 5006 may add critical points to preserve a certain balance, as explained with respect to FIG. 6B.

In determining the critical points, the critical point abstraction 5006 may consider several principles, including conservativity, balance, and lookahead. FIGS. 6A, 6B, and 6C illustrate these three factors, respectively.

FIG. 6A illustrates a scenario 6000 in which the critical point abstraction 5006 determines a set or quantity of critical points that are too conservative, such that the trajectory follower 5002 may not be able to determine modified control commands that allow a vehicle 6002 to safely navigate the critical points. The vehicle 6002 may be the vehicle 2100 of FIG. 2. The set of critical points includes critical points 6012 approximately left of a planned path 6008 and critical points 6014 approximately right of the planned path 6008. The critical points 6012 are points at or near a perimeter of an object 6004, while the critical points 6014 are points at or near a perimeter of an object 6006. As indicated in FIG. 6A, the modified path 6010, which is based on modified control commands resulting from the critical points 6012 and the critical points 6014, does not allow the vehicle 6002 from passing between the object 6004 and the object 6006. To avoid or mitigate an occurrence of this scenario 6000, the critical point abstraction 5006 selects from among the most limiting non-driveable points as critical points, i.e., non-driveable points that are most offending to the planned path.

FIG. 6B illustrates a scenario 6100 in which the critical point abstraction 5006 determines a set or quantity of critical points that are unbalanced, such that the trajectory follower 5002 may determine modified control commands that cause a vehicle 6102 to oscillate, or ping-pong, between critical points as the vehicle 6102 advances. The vehicle 6102 may be the vehicle 2100 of FIG. 2. The set of critical points includes critical points 6112 approximately left of a planned path 6108 and critical points 6114 approximately right of the planned path 6108. The critical points 6112 are points at or near a perimeter of an object 6104, while the critical points 6114 are points at or near a perimeter of an object 6106. As indicated in FIG. 6B, the modified path 6110, which is based on modified control commands resulting from the critical points 6112 and the critical points 6114, causes the vehicle 6102 to favor driving toward locations that lack critical points, resulting in a potentially side-to-side oscillatory motion as the vehicle 6102 passes between the v 6104 and the object 6106. To avoid or mitigate an occurrence of this scenario 6100, the critical point abstraction 5006 selects from among the non-driveable points such that each critical point on a first lateral side of the vehicle 6102 is approximately symmetrically paired with a point on a second lateral side of the vehicle 6102 opposite the first lateral side with respect to the planned path 6108. In situations where there is an absence of symmetrical non-driveable points on a given lateral side of the vehicle 6102, the critical point abstraction 5006 may inject virtual critical points to achieve symmetry.

FIG. 6C illustrates a scenario 6200 in which the critical point abstraction 5006 determines a set or quantity of critical points that fail to look far enough ahead along a planned path, such that the trajectory follower 5002 may determine modified control commands that cause a vehicle 6202 to collide with an object. The vehicle 6202 may be the vehicle 2100 of FIG. 2. The set of critical points includes critical points 6212 approximately left of a planned path 6208 and critical points 6214 approximately right of the planned path 6208. In particular, the critical points 6212 are points at or near a perimeter of an object 6204, while the critical points 6214 are points at or near a perimeter of an object 6206. As indicated in FIG. 6C, the modified path 6210, which is based on modified control commands resulting from the critical points 6212 and the critical points 6214, causes the vehicle 6202 to collide with the unforeseen object 6216 as the vehicle 6202 passes the object 6204 and the object 6206. To avoid or mitigate an occurrence of this scenario 6200, the critical point abstraction 5006 selects from among the non-driveable points critical points that are most pertinent to avoiding collisions with nearby objects while also selecting at least one or two critical points that are located further ahead on the planned path 6208. For example, the critical point abstraction 5006 may exclude the nearest critical points to the vehicle 6202, shown with dashed outlines in FIG. 6C, and include, or favor, lookahead critical point 6220 and lookahead critical point 6222, shown with solid fills in FIG. 6C. In doing so, the trajectory follower 5002 may determine a modified path 6218 that avoids the otherwise unforeseen object 6216. In some implementations, the critical point abstraction 5006 may determine the critical points such that there are more points located ahead of the vehicle in its longitudinal direction of travel than behind the vehicle.

Returning to FIG. 5, the control barrier function avoidance 5008 determines one or more constraints on the motion of the vehicle based on at least the compensated pose it receives from the input delay compensation 5004 and the critical points it receives from the critical point abstraction 5006. The constraints may comprise one or more lateral motion constraints, such as steering, and/or one or more longitudinal motion constraints, such as braking, e.g., negative acceleration. The lateral motion constraints may be used by the RCAS optimization 5014 to determine a modified lateral control command, and the longitudinal motion constraints may be used by the RCAS optimization 5014 to determine a modified longitudinal control command, as described later herein.

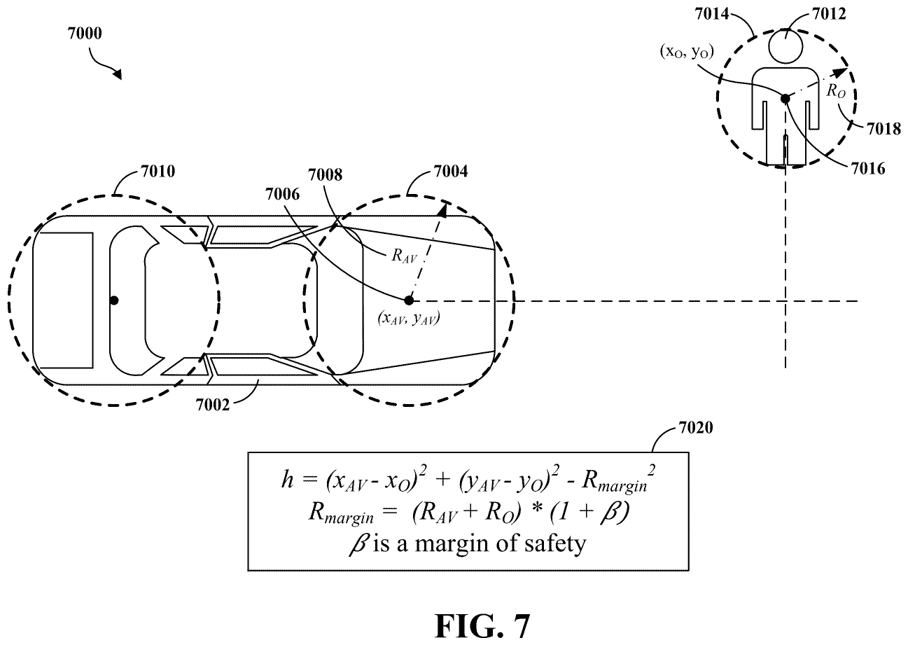

The control barrier function avoidance 5008 utilizes control barrier functions (CBFs). FIG. 7 is a diagram of an example of a framework 7000 for using control barrier functions for avoiding a collision between a vehicle 7002 and an object 7012. The vehicle 7002 may be one of the vehicle 6002, the vehicle 6102, or the vehicle 6202 shown in FIG. 6A, 6B, or 6C, respectively. The vehicle 7002 is modeled by a first circular control barrier function 7004 having a radius 7008 (labeled RAV) and a center 7006 at a midpoint of a front axle of the vehicle 7002 (labeled x_{AV}, y_{AV}), and a second circular control barrier function 7010 having a radius (unlabeled) and a center (unlabeled) at a midpoint of a rear axle of the vehicle 7002. In some implementations, the vehicle 7002 may be modeled by greater or fewer CBFs, and they may utilize various shapes and be centered at various locations of the vehicle 7002. For example, the vehicle 7002 could be modeled by CBFs centered at respective points corresponding to each outermost wheel of the front axle of the vehicle and/or respective points corresponding to each outermost wheel of the rear axle of the vehicle, which may be helpful in helping the wheels from running over potholes, as described later herein.

In FIG. 7, the object 7012 is modeled by a circular control barrier function 7014 having a radius 7018 (labeled R_{O}) and a center 7016 at a geometric center of the object 7012 (labeled x_{O}, y_{O}). In some implementations, the object 7012 may be modeled by greater or fewer CBFs, and they may utilize various shapes and be centered at various locations of the object 7012.

The control barrier function avoidance 5008 determines a circle-to-circle distance between each CBF of the vehicle 7002 and each CBF of the object 7012. For simplicity, FIG. 7 only illustrates the circle-to-circle distance between the circular barrier function 7004 of the vehicle 7002 and the circular control barrier function 7014 of the object 7012, which is also provided below, where h is the circle-to-circle distance, R_{margin} is a safety margin function, and β is a predefined margin of safety.

$$h = {( {x}_{AV} - {x}_{o} )}^{2} + {( {y}_{A V} - {y}_{o} )}^{2} - {R}_{m a r g i n}^{2}$$

$${R}_{m a r g i n} = ( {R}_{A V} + {R}_{o} ) * ( 1 + β )$$

A goal of the control barrier function avoidance 5008 is to ensure that h>0 for all times under consideration. This condition means that the vehicle 7002 must not get within R_{margin} of the object 7012. For implementations where the vehicle 7002 is modeled by the front circular control barrier function 7004 and the rear circular control barrier function 7010, the control barrier function avoidance 5008 determines two circle-to-circle distances, h_{front} and hᵣₑₐᵣ, and a goal is to ensure h_{front}>0 and hᵣₑₐᵣ>0 for all times under consideration. In general, for implementations where the vehicle 7002 is modeled by i>0 CBFs and the object 7012 is modeled by j>0 CBFs, the control barrier function avoidance 5008 determines i*j circle-to-circle distances, and a goal is to ensure every h_{i,j}>0 for all i, j for all times under consideration. For simplicity and without loss of generality, the remaining description for the control barrier function avoidance 5008 will assume only a single circle-to-circle distance, h, is under consideration unless otherwise noted. Further, the term circle-to-circle distance may be referred to herein simply as a distance.

To avoid a collision situation, e.g., where the distance h≤0, the control barrier function avoidance 5008 determines a rate of change of h, e.g., how quickly the distance is decreasing. The rate of change of h indicates a likelihood of a potential collision between the vehicle 7002 and the object 7012. If the rate of change of the distance indicates a rapid decrease that exceeds a predefined threshold (e.g., the rate of change is more negative than the predefined threshold), an evasive maneuver of the vehicle 7002 may be required to avoid a collision. For simplicity, assume the object 7012 is stationary. The rate of change of the distance may be determined based on a kinematic bicycle model shown below, where L_{f} and Lᵣ denote a length of the vehicle 7002 from center to front and center to rear, respectively, δ denotes a steering angle, a denotes a linear acceleration, vₓ denotes a linear velocity of the vehicle 7002, and the other variables and dotted forms thereof are as described earlier.

$$\dot{x} = {v}_{x} cos ( θ )$$

$$\dot{y} = {v}_{x} sin ( θ )$$

$$\dot{θ} = {v}_{x} \frac{δ}{{L}_{f} + {L}_{r}}$$

$${\dot{v}}_{x} = a$$

The control barrier function avoidance 5008 may determine the rate of change of the distance, \dot{h}, by differentiating the distance, h, as follows.

$$h = {( {x}_{AV} - {x}_{o} )}^{2} + {( {y}_{AV} - {y}_{o} )}^{2} - {R}_{m a r g i n}$$

$$\dot{h} = 2 ( {x}_{A V} - {x}_{o} ) {v}_{x} cos ( θ ) + 2 ( {y}_{A V} - {y}_{o} ) {v}_{x} sin ( θ )$$

A second derivate of h, \ddot{h}, reveals the current control commands, specifically, the current lateral control command, δ (e.g., the current steering command), and the current longitudinal control command, a (e.g., the acceleration/braking command), as shown below.

$$\ddot{h} = 2 {v}_{x}^{2} + 2 [ ( {x}_{A V} - {x}_{o} ) cos ( θ ) + ( {y}_{A V} - {y}_{o} ) sin ( θ ) ] a + \frac{2 {v}_{x}^{2}}{{L}_{f} + {L}_{γ}} [ - ( {x}_{AV} - {x}_{o} ) sin ( θ ) + ( {y}_{A V} - {y}_{o} ) cos ( θ ) ] δ$$

Given the direct connection between the rate of change of the distance, \dot{h}, and the current control commands, δ and a, described above, an inequality constraint can be formulated that restricts the vehicle 7002 from approaching the object 7012 too quickly. However, such an approach does not use prediction; rather, it compares the current distance to a next distance in a next iteration based on a predefined time step. This approach may be computationally intensive and impractical or infeasible to implement. Instead, it is sufficient to impose that the rate of change of the distance, h, not exceed an exponential decay, as shown below, where a is an empirically determined tuning parameter, to guarantee that h>0 for all times under consideration, e.g., time steps t₀<t₁< . . . .

$$\dot{h} + α h \geq 0 for α > 0$$

$$\dot{h} + α h \geq 0 ⇒ {h}_{{t}_{1}} \geq {h}_{{t}_{0}} {e}^{- α ( {t}_{1} - {t}_{0} )}$$

Accordingly, for the simplified example provided above, the control barrier function avoidance 5008 determines the circle-to-circle distance, h, between the vehicle 7002 and the object 7012; it determines a rate of change of the circle-to-circle distance; it determines whether the rate of change exceeds a predefined threshold; and it determines a prediction, based on the collision function of the circle-to-circle distance, that the current control commands will result in a collision between the vehicle 7002 and the object 7012. For implementations where the vehicle 7002 is modeled by i>0 CBFs and one or more objects 7012 are modeled by j>0 CBFs, the control barrier function avoidance 5008 determines i*j circle-to-circle distances; it determines a rate of change for each of the circle-to-circle distances; it determines whether any rate of change exceeds a predefined threshold; and it determines a prediction, based on a collision function of each circle-to-circle distance whose rate of change exceeds the predefined threshold, that the current control commands will result in a collision between the vehicle 7002 and at least one of the one or more objects 7012. These predictions are provided to the RCAS optimization 5014 as constraints.

The empirically determined tuning parameter, α, in the exponentially decaying collision function described above can be tuned to vary a risk tolerance for a collision with an object. In general, each object k is associated with a its own tuning parameter, αₖ, which is used in the corresponding collision function. A higher αₖ means the vehicle 7002 can pass closer to the object without the vehicle 7002 taking evasive actions, and a lower αₖ means the reactive collision avoidance system, e.g., the trajectory follower 5002, will override, or adjust, the control commands received from the proactive risk mitigation system, e.g., the planner system 4008, at larger circle-to-circle distances. In some implementations, the tuning parameter, αₖ(vₓ), may be a function of velocity, such as an absolute velocity of the vehicle 7002 or a relative velocity of the vehicle 7002 with respect to the object 7012.

If the object 7012 is moving instead of stationary as assumed above, then two kinematic bicycle models may be used to determine the rate of change of the distance, h, between the vehicle 7002 and the object 7012. In other words, the model would account for relative linear velocity between the (moving) vehicle 7002 and the (moving) object 7012. For example, assume the object 7012 is a truck having a different wheelbase than the vehicle, such that L*_{f} and L*ᵣ denote lengths of the truck from center to front and center to rear, respectively. Given a linear velocity v*ₓ and a pose (x*, y*, θ*) of the truck, its kinematic bicycle model would be the same as that shown above for the vehicle 7002 but using the given asterisked variables. Accordingly, the rate of change of the distance, \dot{h}, would contain more terms because x*, y*, and θ* change based on the trucks velocity and wheelbase.

Returning to FIG. 5, the nominal controller 5012 receives the planned path from the planner system 4008 as indicated earlier. The nominal controller 5012 also receives the compensated pose from the input delay compensation 5004. The nominal controller 5012 determines the nominal control commands according to the planned path it then compensates the nominal control commands according to the compensated pose, and provides the compensated nominal control commands to the control Lyapunov function tracking 5010 and the RCAS optimization 5014.

The control Lyapunov function tracking 5010 receives the planned path from the planner system 4008, the compensated pose from the input delay compensation 5004, and the compensated nominal control commands from the nominal controller 5012. An objective of the control Lyapunov function tracking 5010 is to enable enforcement of tracking of the vehicle along a curvature of the planned path. The control Lyapunov function tracking 5010 determines a currently achieved curvature, K, based on an equation κ=\dot{θ}/v (where \dot{θ} is the yaw rate and vis the longitudinal velocity), which may be determined, for example, from compensated poses. The control Lyapunov function tracking 5010 further determines a desired curvature, κ_{comp}, based on, for example, compensated poses and compensated nominal control commands. The control Lyapunov function tracking 5010 compares the planned curvature to the desired curvature based on the equation shown below, and outputs the resulting curvature inequality, V, to the RCAS optimization 5014 for enforcement, where the magnitude of V indicates a degree of tracking (V=0 indicates perfect tracking).

$$V = {( κ - {κ}_{c o m p} )}^{2}$$

Curvature-based CLFs are known in the art, for example, as described in “Control barrier function-based lateral control of autonomous vehicle for roundabout crossing,” 2021 IEEE International Intelligent Transportation Systems Conference (ITSC), and are not described further herein.

The RCAS optimization 5014 receives the constraints from the control barrier function avoidance 5008 (the collision predictions) and the control Lyapunov function tracking 5010 (the curvature inequality), the compensated nominal control commands (steering and acceleration/braking) from the nominal controller 5012, and other constraints such as vehicle constraints (e.g., actuator limitations) and comfort constraints (e.g., lateral forces, jerk, etc.). An objective of the RCAS optimization 5014 is to determine collision-free acceleration/braking and collision-free steering commands under the provided constraints.

In particular, the curvature inequality ensures that, when no late-deterministic collision threat is present, the RCAS outputs—e.g., unmodified compensated nominal control commands-maintain curvature tracking. The curvature inequality further ensures that, when a late-deterministic collision threat is present and collision avoidance is performed by the control barrier function avoidance 5008 as described above, the RCAS outputs—e.g., modified control commands which are modified versions of the compensated nominal control commands—bias the vehicle to resume path curvature tracking.

In some implementations, the RCAS optimization 5014 may minimize deviations between the control commands received from the planner system 4008 and the modified control commands, e.g., the collision-free steering and the collision-free acceleration/braking. For implementations where the vehicle 7002 is modeled by a front CBF

$$\dot{{h}_{f ront}} , ,$$

and a rear CBF,

$$\dot{{h}_{r e a r}} ,$$

and considering a single object, minimizing deviations between the control commands and the modified control commands can be determined according to the following equations.

$$\dot{{h}_{f ront}} + {α}_{f ront} {h}_{f ront} \geq 0 ⇒ {h}_{f ront} ( {t}_{1} ) \geq {e}^{- {α}_{front} ( {t}_{1} - {t}_{0} )} {h}_{f ront} ( {t}_{0} )$$

$$\dot{{h}_{r e a r}} + {α}_{r e a r} {h}_{r e a r} \geq 0 ⇒ {h}_{r e a r} ( {t}_{1} ) \geq {e}^{- {α}_{r e a r} ( {t}_{1} - {t}_{0} )} {h}_{r e a r} ( {t}_{0} )$$

For implementations where the vehicle 7002 is modeled by a front CBF,

$$\dot{{h}_{f ront}} ,$$

and a rear CBF,

$$\dot{{h}_{r e a r}} ,$$

and considering multiple objects, minimizing deviations between the control commands and the modified control commands can be determined according to the following equations.

$$\dot{{h}_{ι , front}} + {α}_{i , f ront} {h}_{i , front} \geq 0 ⇒ {h}_{i , f ront} ( {t}_{1} ) \geq {e}^{- {α}_{i , front} ( {t}_{1} - {t}_{0} )} {h}_{i , f r o n t} ( {t}_{0} )$$

$$\dot{{h}_{ι , r e a r}} + {α}_{i , r e a r} {h}_{i , rear} \geq 0 ⇒ {h}_{r e a r} ( {t}_{1} ) \geq {e}^{- {α}_{i , rear} ( {t}_{1} - {t}_{0} )} {h}_{i , rear} ( {t}_{0} )$$

$$for all i ∈ \{ 1 , … , N \}$$

In some implementations, the RCAS optimization 5014 may determine the modified control commands under the vehicle constraints, and more specifically, determine at least one modified control command based on adhering to functional constraints of one or more actuators of the vehicle that execute the control commands.

In some implementations, the RCAS optimization 5014 may determine the modified control commands under the comfort constraints, and more specifically, determine at least one modified control command based on adhering to comfort constraints of one or more occupants of the vehicle.

In some implementations, the RCAS optimization 5014 may determine the modified control commands based on a predefined preference for modifying one of a lateral control command, e.g., a steering command, or a longitudinal control command, e.g., a braking command.

In some implementations, the RCAS optimization 5014 may determine the modified control commands based on a predefined preference for lateral control commands over longitudinal control commands or vice versa. Specifically, in determining the modified control commands, the RCAS optimization 5014 may modify lateral control commands and longitudinal control commands by respective amounts according to a predefined ratio that represents the predefined preference.

In some implementations, the RCAS optimization 5014 may determine the modified control commands based on a speed of the vehicle. Specifically, in determining the modified control commands, the RCAS optimization 5014 may modify lateral control command and longitudinal control command by respective amounts based on a speed of the vehicle and a curvature of the planned path (or a curvature of the compensated path).

For simplicity of explanation, each technique, or process, is depicted and described herein as a series of steps or operations. However, the steps or operations of the techniques in accordance with this disclosure can occur in various orders and/or concurrently. Additionally, other steps or operations not presented and described herein may be used. Furthermore, not all illustrated steps or operations may be required to implement a technique in accordance with the disclosed subject matter.

The technique 8000 described below is a technique for reactive collision avoidance. This technique may be implemented by a system whose components may be internal and/or external to a vehicle, such as the controller 1300 of FIG. 1 or the computing apparatus 2410 of the data center 2400 of FIG. 2.

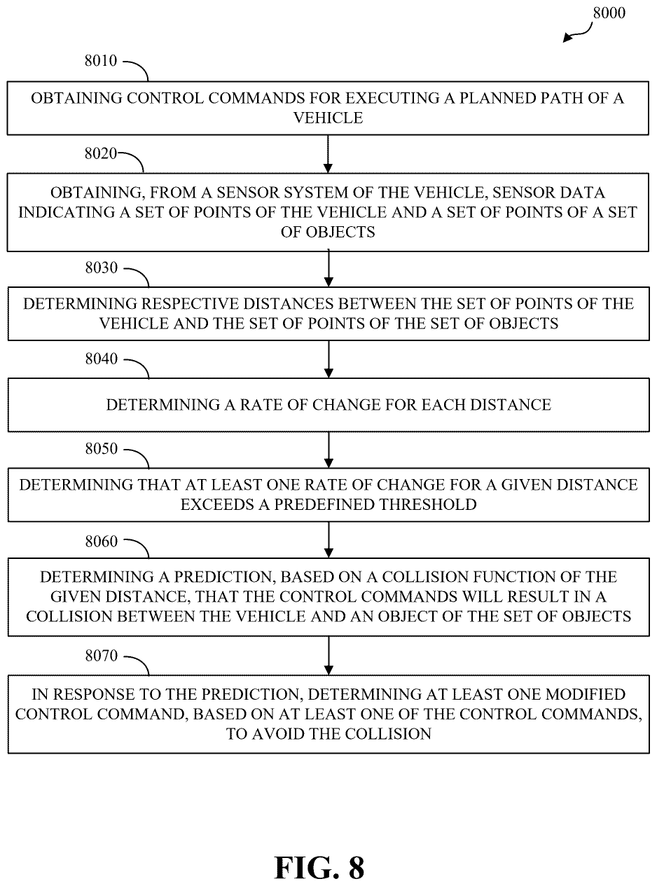

FIG. 8 is a flowchart of an example of a process for reactive collision avoidance. The step 8010 comprises obtaining control commands for executing a planned path of a vehicle. The vehicle may be the vehicle 7002 of FIG. 7. The planned path may be one of the planned paths indicated in FIG. 4, FIG. 5, or FIG. 6A-6C. The control commands may be one of the control commands indicated in FIG. 4 or FIG. 5. In some implementations, the control commands may be obtained directly from a proactive risk mitigation system, such as the planner system 4008 shown in FIG. 4. In some implementations, the control commands may be determined from a planned path, received from a proactive risk mitigation system, such the planner system 4008 shown in FIG. 4, by a component of the reactive collision avoidance system, such as the nominal controller 5012 shown in FIG. 5. In some implementations, the control commands comprise at least one of: a lateral control command; or a longitudinal control command.

The step 8020 comprises obtaining, from a sensor system of the vehicle, sensor data indicating a set of points of the vehicle and a set of points of a set of objects. The sensor system may be the sensor 1360 shown in FIG. 1. The sensor data may be the data indicated by the world 4002 shown in FIG. 4. The set of points of the vehicle may be the center points indicated in FIG. 7, including the center 7006. In some implementations, the set of points of the vehicle comprises at least one of: a point corresponding to a front axle of the vehicle; or a point corresponding to a rear axle of the vehicle. In some implementations, the set of points of the vehicle comprises at least one of: a point corresponding to a front wheel of the vehicle; or a point corresponding to a rear wheel of the vehicle, which may be helpful in helping the wheels from running over potholes. Specifically, when the set of points of the vehicle correspond to the wheels, the vehicle can straddle a pothole between the wheels to avoid the pothole, whereas the vehicle would likely have to drive around the pothole given the set of points corresponding to the midpoints of the axles of the vehicle. The set of objects may comprise the objects 6004 and 6006 shown in FIG. 6A, the objects 6104 and 6106 shown in FIG. 6B, the objects 6104 and 6206 shown in FIG. 6C, or the object 7012 shown in FIG. 7. The set of points for the set of objects may comprise the critical points 6012 and 6014 shown in FIG. 6A, the critical points 6112 and 6114 shown in FIG. 6B, or the critical points 6212 and 6214 shown in FIG. 6C.

In some implementations, the process includes an additional step of determining the set of points of the set of objects such that each point on a first lateral side of the vehicle is approximately symmetrically paired with a point on a second lateral side of the vehicle opposite the first lateral side with respect to the planned path. In some implementations, the process includes an additional step of determining the set of points of the set of objects to consist of points that favor a predefined lookahead distance from the vehicle. In some implementations, the process includes an additional step of determining the set of points of the set of objects such that there are more points located ahead of the vehicle in its longitudinal direction of travel than behind the vehicle.

The step 8030 comprises determining respective distances between the set of points of the vehicle and the set of points of the set of objects. The respective distances may be determined by a control barrier function avoidance component of the reactive collision avoidance system, such as the control barrier function avoidance 5008 shown in FIG. 5. In some implementations, each point of the set of points of the vehicle and each point of the set of points of the set of objects corresponds to a center of a circle; and each distance of the set of distances is determined based on a circle-to-circle distance of a control barrier function.

The step 8040 comprises determining a rate of change for each distance. The rate of change may be determined by a control barrier function avoidance component of the reactive collision avoidance system, such as the control barrier function avoidance 5008 shown in FIG. 5.

The step 8050 comprises determining that at least one rate of change for a given distance exceeds a predefined threshold. The rate of change may be determined by a control barrier function avoidance component of the reactive collision avoidance system, such as the control barrier function avoidance 5008 shown in FIG. 5. Because collisions between a vehicle and an object are more likely to occur when the occur when the distance decreases rapidly (as opposed to when the distance increases rapidly), the rate of change is generally a negative rate of change and the predefined threshold is a negative quantity, such that the rate of change exceeding the predefined threshold means the rate of change is more negative than the predefined threshold.

The step 8060 comprises determining a prediction, based on a collision function of the given distance, that the control commands will result in a collision between the vehicle and an object of the set of objects. The prediction may be determined by a control barrier function avoidance component of the reactive collision avoidance system, such as the control barrier function avoidance 5008 shown in FIG. 5. In some implementations, the collision function comprises an exponentially decaying function of the distance of the set of distances. In some implementations, the exponential of the exponentially decaying function includes an empirically determined tuning parameter that represents a risk tolerance of the collision, for example, the empirically determined tuning parameter, a, described earlier.

The step 8070 comprises, in response to the prediction, determining at least one modified control command, based on at least one of the control commands, to avoid the collision. The at least one modified control command may be determined by an RCAS optimization component of the reactive collision avoidance system, such as the RCAS optimization 5014 shown in FIG. 5. In some implementations, the prediction is determined at a rate that is approximately an order of magnitude greater than a rate at which the control commands are obtained.

In some implementations, the process includes an additional step of minimizing a deviation between the at least one modified control command and the at least one of the control commands.

In some implementations, the process includes an additional step of determining the at least one modified control command based further on a predefined preference for modifying one of a lateral control command or a longitudinal control command.

In some implementations, the process includes an additional step of determining the at least one modified control command based further on adhering to functional constraints of one or more actuators of the vehicle that execute the control commands.

In some implementations, the process includes an additional step of determining the at least one modified control command based further on adhering to comfort constraints of one or more occupants of the vehicle.

In some implementations, the at least one modified control command comprises a lateral control command and a longitudinal control command, where the process includes an additional step of modifying the lateral control command and the longitudinal control command by respective amounts according to a predefined ratio.

In some implementations, the at least one modified control command comprises a lateral control command and a longitudinal control command, where the process includes an additional step of modifying the lateral control command and the longitudinal control command by respective amounts based on a speed of the vehicle and a curvature of the planned path.

In some implementations, the process includes an additional step of determining a compensated pose from an obtained pose of the vehicle based on a computational delay in determining previous predictions; and determining the at least one modified control command based further on the compensated pose.

The above-described techniques can be implemented as a method, a system, and a non-transitory computer-readable medium, for example, as described below.

In an example implementation as a method, the method comprises: obtaining control commands for executing a planned path of a vehicle; obtaining, from a sensor system of the vehicle, sensor data indicating a set of points of the vehicle and a set of points of a set of objects; determining respective distances between the set of points of the vehicle and the set of points of the set of objects; determining a rate of change for each distance; determining that at least one rate of change for a given distance exceeds a predefined threshold; determining a prediction, based on a collision function of the given distance, that the control commands will result in a collision between the vehicle and an object of the set of objects; and in response to the prediction, determining at least one modified control command, based on at least one of the control commands, to avoid the collision.

In some implementations, the control commands comprise at least one of: a lateral control command; or a longitudinal control command.

In some implementations, the collision function comprises an exponentially decaying function of the distance of the set of distances.

In some implementations, the collision function comprises an exponentially decaying function of the distance of the set of distances; and an exponential of the exponentially decaying function includes an empirically determined tuning parameter that represents a risk tolerance of the collision.

In some implementations, the set of points of the vehicle comprises at least one of: a point corresponding to a front axle of the vehicle; or a point corresponding to a rear axle of the vehicle.

In some implementations, the set of points of the vehicle comprises at least one of: a point corresponding to a front wheel of the vehicle; or a point corresponding to a rear wheel of the vehicle.

In some implementations, each point of the set of points of the vehicle and each point of the set of points of the set of objects corresponds to a center of a circle; and each distance of the set of distances is determined based on a circle-to-circle distance of a control barrier function.

In some implementations, the method further comprises: minimizing a deviation between the at least one modified control command and the at least one of the control commands.

In some implementations, the method further comprises: determining the set of points of the set of objects such that each point on a first lateral side of the vehicle is approximately symmetrically paired with a point on a second lateral side of the vehicle opposite the first lateral side with respect to the planned path.

In some implementations, the method further comprises: determining the set of points of the set of objects to consist of points that favor a predefined lookahead distance from the vehicle.

In some implementations, the method further comprises: determining the at least one modified control command based further on a predefined preference for modifying one of a lateral control command or a longitudinal control command.

In some implementations, the method further comprises: determining the at least one modified control command based further on adhering to functional constraints of one or more actuators of the vehicle that execute the control commands.

In some implementations, the method further comprises: determining the at least one modified control command based further on adhering to comfort constraints of one or more occupants of the vehicle.

In some implementations, the at least one modified control command comprises a lateral control command and a longitudinal control command, and the method further comprises: modifying the lateral control command and the longitudinal control command by respective amounts according to a predefined ratio.

In some implementations, the at least one modified control command comprises a lateral control command and a longitudinal control command, and the method further comprises: modifying the lateral control command and the longitudinal control command by respective amounts based on a speed of the vehicle and a curvature of the planned path.

In some implementations, the prediction is determined at a rate that is approximately an order of magnitude greater than a rate at which the control commands are obtained.

In some implementations, the method further comprises: determining a compensated pose from an obtained pose of the vehicle based on a computational delay in determining previous predictions; and determining the at least one modified control command based further on the compensated pose.

In another example implementation as a non-transitory computer-readable medium, the non-transitory computer-readable medium stores instructions operable to cause one or more processors to perform operations comprising: obtaining control commands for executing a planned path of a vehicle; obtaining, from a sensor system of the vehicle, sensor data indicating a set of points of the vehicle and a set of points of a set of objects; determining respective distances between the set of points of the vehicle and the set of points of the set of objects; determining a rate of change for each distance; determining that at least one rate of change for a given distance exceeds a predefined threshold; determining a prediction, based on a collision function of the given distance, that the control commands will result in a collision between the vehicle and an object of the set of objects; and in response to the prediction, determining at least one modified control command, based on at least one of the control commands, to avoid the collision.

In some implementations, the set of points of the vehicle comprises at least one of: respective points corresponding to each outermost wheel of a front axle of the vehicle; or respective points corresponding to each outermost wheel of a rear axle of the vehicle.

In another example implementation as a system, the system comprises one or more memories; and one or more processors configured to execute instructions stored in the one or more memories to: obtain control commands for executing a planned path of a vehicle; obtain, from a sensor system of the vehicle, sensor data indicating a set of points of the vehicle and a set of points of a set of objects; determine respective distances between the set of points of the vehicle and the set of points of the set of objects; determine a rate of change for each distance; determine that at least one rate of change for a given distance exceeds a predefined threshold; determine a prediction, based on a collision function of the given distance, that the control commands will result in a collision between the vehicle and an object of the set of objects; and in response to the prediction, determine at least one modified control command, based on at least one of the control commands, to avoid the collision.

As used herein, the terminology “example,” “embodiment,” “implementation,” “aspect,” “feature,” or “element” indicates serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “determine” and “identify,” or any variations thereof, includes selecting, ascertaining, computing, looking up, receiving, determining, establishing, obtaining, or otherwise identifying or determining in any manner whatsoever using one or more of the devices shown and described herein.

As used herein, the terminology “or” is intended to mean an inclusive “or” rather than an exclusive “or”. That is, unless specified otherwise, or clear from context, “X includes A or B” is intended to indicate any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form.

Further, for simplicity of explanation, although the figures and descriptions herein may include sequences or series of steps or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure. Although aspects, features, and elements are described herein in particular combinations, each aspect, feature, or element may be used independently or in various combinations with or without other aspects, features, and elements.

The above-described aspects, examples, and implementations have been described to allow easy understanding of the disclosure are not limiting. On the contrary, the disclosure covers various modifications and equivalent arrangements included within the scope of the appended claims, which scope is to be accorded the broadest interpretation to encompass all such modifications and equivalent structure as is permitted under the law.

What is claimed is:

1. A method, comprising:
obtaining control commands for executing a planned path of a vehicle;
obtaining, from a sensor system of the vehicle, sensor data indicating a set of points of the vehicle and a set of points of a set of objects;
determining respective distances between the set of points of the vehicle and the set of points of the set of objects;
determining a rate of change for each distance;
determining that at least one rate of change for a given distance exceeds a predefined threshold;
determining a prediction, based on a collision function of the given distance, that the control commands will result in a collision between the vehicle and an object of the set of objects; and
in response to the prediction, determining at least one modified control command, based on at least one of the control commands, to avoid the collision.

2. The method of claim 1, wherein the control commands comprise at least one of:
a lateral control command; or
a longitudinal control command.

3. The method of claim 1, wherein:
the collision function comprises an exponentially decaying function of the distance of the set of distances.

4. The method of claim 1, wherein:
the collision function comprises an exponentially decaying function of the distance of the set of distances; and
an exponential of the exponentially decaying function includes an empirically determined tuning parameter that represents a risk tolerance of the collision.

5. The method of claim 1, wherein the set of points of the vehicle comprises at least one of:
a point corresponding to a front axle of the vehicle; or
a point corresponding to a rear axle of the vehicle.

6. The method of claim 1, wherein the set of points of the vehicle comprises at least one of:
a point corresponding to a front wheel of the vehicle; or
a point corresponding to a rear wheel of the vehicle.

7. The method of claim 1, wherein:
each point of the set of points of the vehicle and each point of the set of points of the set of objects corresponds to a center of a circle; and
each distance of the set of distances is determined based on a circle-to-circle distance of a control barrier function.

8. The method of claim 1, further comprising:
minimizing a deviation between the at least one modified control command and the at least one of the control commands.

9. The method of claim 1, further comprising:
determining the set of points of the set of objects such that each point on a first lateral side of the vehicle is approximately symmetrically paired with a point on a second lateral side of the vehicle opposite the first lateral side with respect to the planned path.

10. The method of claim 1, further comprising:
determining the set of points of the set of objects to consist of points that favor a predefined lookahead distance from the vehicle.

11. The method of claim 1, further comprising:
determining the at least one modified control command based further on a predefined preference for modifying one of a lateral control command or a longitudinal control command.

12. The method of claim 1, further comprising:
determining the at least one modified control command based further on adhering to functional constraints of one or more actuators of the vehicle that execute the control commands.

13. The method of claim 1, further comprising:
determining the at least one modified control command based further on adhering to comfort constraints of one or more occupants of the vehicle.

14. The method of claim 1, wherein the at least one modified control command comprises a lateral control command and a longitudinal control command, the method further comprising:
modifying the lateral control command and the longitudinal control command by respective amounts according to a predefined ratio.

15. The method of claim 1, wherein the at least one modified control command comprises a lateral control command and a longitudinal control command, the method further comprising:
modifying the lateral control command and the longitudinal control command by respective amounts based on a speed of the vehicle and a curvature of the planned path.

16. The method of claim 1, wherein:
the prediction is determined at a rate that is approximately an order of magnitude greater than a rate at which the control commands are obtained.

17. The method of claim 1, further comprising:
determining a compensated pose from an obtained pose of the vehicle based on a computational delay in determining previous predictions; and
determining the at least one modified control command based further on the compensated pose.

18. A non-transitory computer-readable medium storing instructions operable to cause one or more processors to perform operations comprising:
obtaining control commands for executing a planned path of a vehicle;
obtaining, from a sensor system of the vehicle, sensor data indicating a set of points of the vehicle and a set of points of a set of objects;
determining respective distances between the set of points of the vehicle and the set of points of the set of objects;
determining a rate of change for each distance;
determining that at least one rate of change for a given distance exceeds a predefined threshold;
determining a prediction, based on a collision function of the given distance, that the control commands will result in a collision between the vehicle and an object of the set of objects; and
in response to the prediction, determining at least one modified control command, based on at least one of the control commands, to avoid the collision.

19. The medium of claim 18, wherein the set of points of the vehicle comprises at least one of:
respective points corresponding to each outermost wheel of a front axle of the vehicle; or
respective points corresponding to each outermost wheel of a rear axle of the vehicle.

20. A system, comprising:
one or more memories; and
one or more processors configured to execute instructions stored in the one or more memories to:
obtain control commands for executing a planned path of a vehicle;
obtain, from a sensor system of the vehicle, sensor data indicating a set of points of the vehicle and a set of points of a set of objects;
determine respective distances between the set of points of the vehicle and the set of points of the set of objects;
determine a rate of change for each distance;
determine that at least one rate of change for a given distance exceeds a predefined threshold;
determine a prediction, based on a collision function of the given distance, that the control commands will result in a collision between the vehicle and an object of the set of objects; and
in response to the prediction, determine at least one modified control command, based on at least one of the control commands, to avoid the collision.
